(19) United States
(12) Patent Application Publication
(10) Pub. No.: US 2004/0210584 A1
(43) Pub. Date: Oct. 21, 2004

(54) Method and apparatus for increasing file server performance by offloading data path processing

(76) Inventors: Peleg Nir, Beer Yaakov (IL); Stein Eli, Zichron Yaakov (IL)

Correspondence Address: KATTEN MUCHIN ZAVIS ROSENMAN, 575 MADISON AVENUE, NEW YORK, NY, 10022-2585, US

(21) Appl. No.: 10/787,341

(22) Filed: Feb. 25, 2004

Related U.S. Application Data
(60) Provisional application No. 60/450,346, filed on Feb. 28, 2003.

(51) Int. Cl. G06F 17/30; G06F 7/00

(52) U.S. Cl. 707/10; 707/3

(57) ABSTRACT

A method and apparatus for offloading data path processing for the purpose of increasing the performance of a file server, is disclosed. The apparatus provides a direct data-path that avoids the need for a host-based file sharing (e.g., NFS, CIFS, etc.) protocol processing for most file system requests. As a result, data transfer rate is greatly accelerated and time-intensive processing tasks are diverted from the host CPU. The apparatus separates the control path from the data path. A preferred embodiment connects peripheral channels, such as SCSI or Fibre Channel to TCP/IP over Fast Ethernet.

This invention takes priority from U.S. provisional Pat. application No. 60/450,346, filed on Feb. 28, 2003.

### TECHNICAL FIELD

The invention relates generally to network file server architectures, and more particularly, to an apparatus and method for increasing the offloading performance of network file servers.

### BACKGROUND OF THE INVENTION

Over the past decade, there is a tremendous growth of computer networks. However, with this growth, dislocations and bottlenecks have occurred in utilizing conventional network devices. For example, a CPU of a computer connected to a network may spend an increasing proportion of its time processing network communications, leaving less time available for other important tasks. In particular, demands of transferring data between the network and the storage units of the computer have significantly increased both in volume as well as in the expected response time.

Conventionally, data transferred through a computer network is divided into packets, where each packet encapsulated in layers of control information that are processed one at a time by the CPU of the receiving computer. Although the speed of CPUs has significantly increased, this protocol processing of network messages, such as file transfers, can consume most of the available processing power of even the fastest commercially available CPU.

This situation may be even more challenging for a network file server having a primary function of storing and retrieving files from its attached disk or tape drives over the network. As networks and databases have grown, the volume of information stored on such servers has exploded, exposing the limitations of such server-attached storage.

Reference is now made to FIG. 1 where an overview of prior art of network storage system 100 is shown. System 100 includes a file server 180 connected to a plurality of clients 170 through network 130. Network 130 may be, but is not limited to, a local area network (LAN) or a wide area network (WAN). File server 180 comprises a central processing unit (CPU) 110, working memory 115, a network interface (NIC) 120, a storage interface 160, and a system internal bus 140. The host's CPU 110 is connected to network 130, through a NIC 120. The host's CPU 110 is connected to NIC 120 by an internal bus 140, such as a peripheral component interconnect (PCI) bus. System 100 further includes a storage device 150 connected to internal bus 140 through a storage interface 160. Storage device 150 may be a disk drive, a collection of disk drives, a tape drive, a redundant array of independent (or inexpensive) disks (RAID), and the like. Storage device 150 is attached to storage interface 160 through a peripheral channel 155, such as Fibre Channel (FC), small computer system interface (SCSI), and the likes. The host's CPU 110 is connected to the working memory 115 for controlling various tasks, including a file system and communication messages' processing.

Following is an example illustrating a conventional data flow from storage device 150, to client 170 through network 130. Client 170 initiates data retrieval by sending a read request, which includes the file identifier, the size of the requested data block, and the offset in the file. The request is received by NIC 120 which processes the link, network, and the transport layer headers of the received packets. The host's CPU 110 performs file sharing protocol (FPS) processing, such as verifying the location of the file in storage device 150, checking the access permission of clients 170, and so forth. If client 170 is authorized to access the requested file, then the host's CPU 110 retrieves the requested data block from storage device 150 and stores it temporarily in the host's working memory 115. Before sending back the requested data block to client 170, the host's CPU 110 performs transport layer processing, i.e., TCP processing on the data block. For that purpose the host's CPU 110 breaks up the data block, which is temporarily residing in the host's working memory 115, into segments, affixing a header to each segment, and sending the segment (one segment at a time) to the destination client 170.

As can be understood from this example, there are two major data paths: between network 130 and the host's working memory 115 via NIC 120; and between storage device 150 and the host's working memory 115 via storage interface 160. These data paths are also established when the system performs a write request and stores data on storage device 150.

Consequently, the data flow between network 130 and storage device 150 is inefficient, mainly because of the following limitations: a) the host's working memory 115 bandwidth is used inefficiently and limits data transfer speed b) data is transferred back and forth across an already congested internal bus 140; c) the host's CPU 110 manages the data transference from and to the host's working memory 115, a time consuming task; and, d) the host's working memory 115 must be large enough to store the data transferred from storage device 150 to client 170. All of these drawbacks significantly limit the performance of file server 180 and thus the performance of the entire storage system 100.

In the related art, there are systems that provide direct data paths from network 130 to storage device 150. Examples for such systems are disclosed in U.S. Pat. No. 6,535,518 and in U.S. Pat. application Ser. No. 10/172,853. The disclosed systems are designed to address the specific needs of streaming media, video on demand, and web applications. Furthermore, the systems are based on a routing table that includes routing information. The routing information allows bypassing file server 180 for massive data transfers. Using routing table for bypassing file server 180 for a File Service Protocol (FSP) processing is inefficient, since it requires modifying the operating system (OS) of file server 180. A FSP may be any high-level protocol used for sharing files data across a network system, such as a network file system (NFS), a common Internet file system (CIFS), a direct access file system (DAFS), AppleShare, and the like. CIFS was developed by Microsoft® to allow file sharing across a Windows network (NT)® platform and it uses the Transmission Control Protocol (TCP) as a transport layer. NFS allows clients to read and change remote files as if they were stored on a local hard drive and store files on remote servers. Both NFS and CIFS are well familiar to those who are skilled in the art.

In the view of the shortcomings in the related art it would therefore be advantageous to provide a solution for offloading file sharing processing in a storage network system.

### BRIEF DESCRIPTION OF THE DRAWINGS

FIG. 1 illustrates a schematic diagram of prior art of a network storage system;

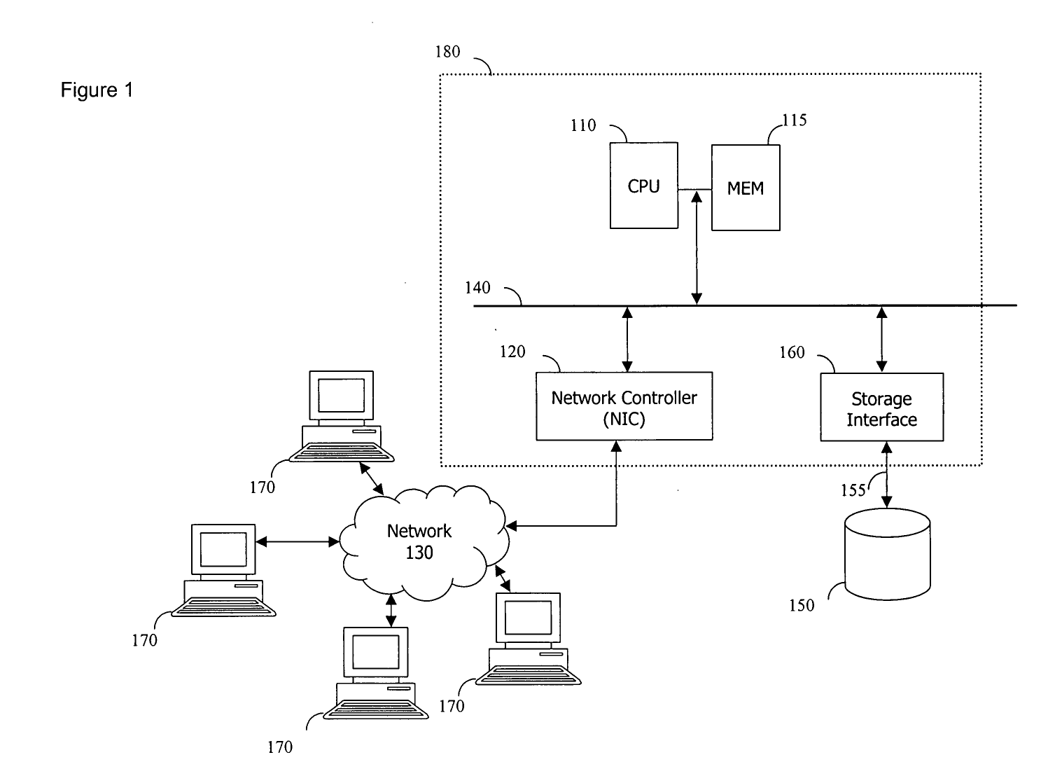

FIG. 2 illustrates a schematic diagram of a network storage system including a gateway, according to the present invention;

FIG. 3 illustrates a block diagram of the gateway, according to the present invention;

FIG. 4 is a flowchart illustrating the method for handling file system requests, according to the present invention;

FIG. 5 is a flowchart illustrating the method for executing a read request, according to the present invention;

FIG. 6 is a flowchart illustrating the method for executing a write request, according to the present invention.

### DETAILED DESCRIPTION OF THE INVENTION

The present invention provides an efficient solution for the present day file sharing problems as described above. The preferred embodiment of the present invention transfers the file sharing tasks to a gateway which is integrated into a host server, e.g., a file server. The gateway makes the host server's file sharing process much more efficient and significantly reduces the processing loads from the host's CPU.

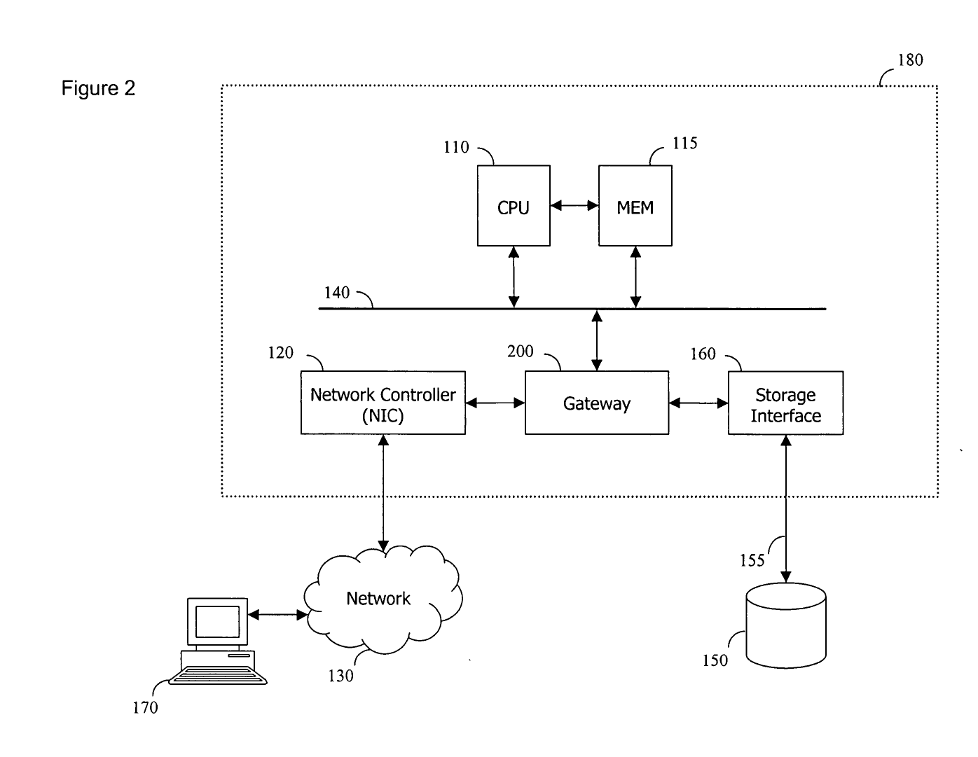

Reference is now made to FIG. 2 that illustrates a file server 180 including a gateway 200 in accordance with an embodiment of the present invention. Gateway 200 is connected to a network interface card (NIC) 120, the host's CPU 110, and to the storage interface 160 using an internal bus 140. The NIC 120 and storage interface 160 are further connected to the host's CPU 110 through the bus 140. Gateway 200 comprises mechanisms for processing the file sharing protocols (FSPs) including, but not limited to, network file system (NFS), common internet file system (CIFS), direct access file system (DAFS), AppleShare, and the like. In essence, gateway 200 provides an accelerated direct data path between NIC 120 and storage interface 160 through interconnected peripheral channels 155, such as peripheral component interconnect (PCI). Hence, in order to read a data block from a file or write a data block to a file, the data processing procedure does not involve the host's CPU 110 and working memory 115. By providing an accelerated direct data path, gateway 200 significantly improves the performance of file server 180. In other embodiments of the present invention file server 180 may function as part of storage area network (SAN), network attached storage (NAS), direct attached storage (DAS), and the like.

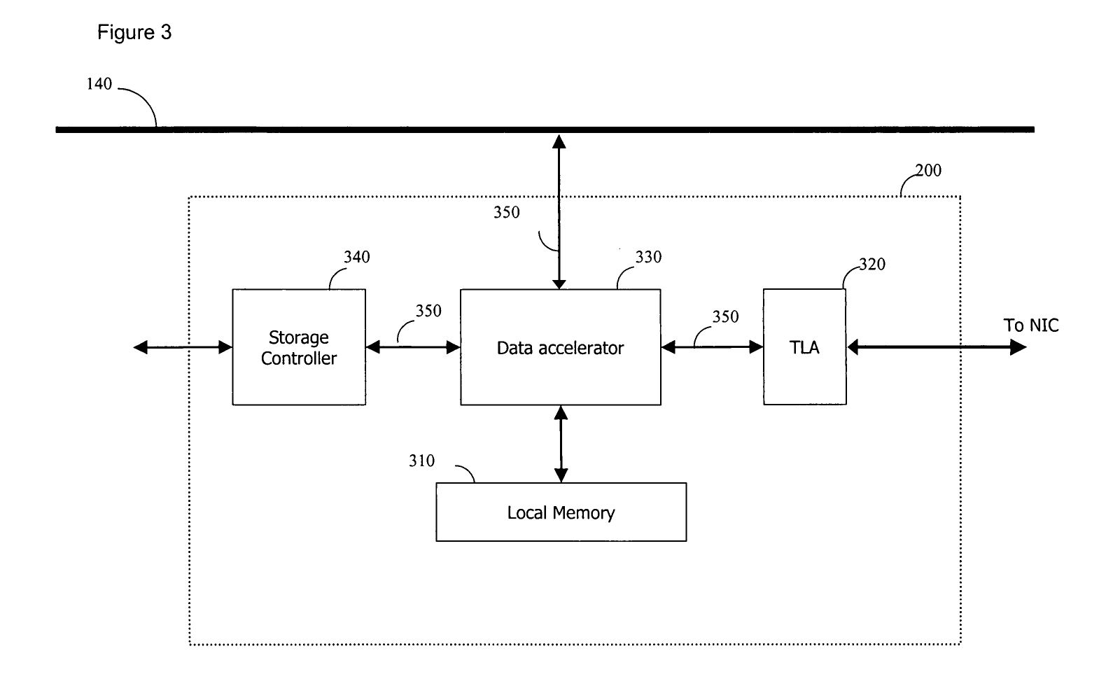

Reference is now made to FIG. 3 where an exemplary block diagram of gateway 200 in accordance with an embodiment of the present invention, is shown. Gateway 200 comprises, a data accelerator unit 330 connected to a local memory 310, a transport layer accelerator (TLA) 320, and storage controller 340. Local memory 310 is used to hold temporary files data transferred between network 130 and storage device 150. In addition, local memory 310 holds the FSP requests received from client 170. Local memory 310 may include a cache memory for accelerating data access. Address space of local memory 310 is mapped to the address space of the host's working memory 115 to allow maintaining data coherency between these memories. The TLA 320 is an offload engine used for offloading transport layer processing, e.g., TCP processing for NFS or CIFS connections. Storage controller 340 allows access to storage device 150. Storage controller 340 may be a disk controller, a Fibre Channel (FC) controller, a SCSI controller, a parallel SCSI (pSCSI, an iSCSI, a parallel ATA (PATA) or a serial ATA (SATA) and the like. A data accelerator unit 330 is connected to TLA 320, the host's CPU 110, and storage controller 340, through interconnected bus (e.g., a PCI bus) 350.

The data accelerator unit 330 functions as the direct path between NIC 120 and storage interface 160. The data accelerator unit 330 transfers data files through gateway 200 at higher-speed in comparison to data transfer through the CPU data bus. Specifically, data accelerator unit 330 receives FSP requests from client 170 and processes the requests so that data blocks are not transferred through system's internal bus 140 or through the host's working memory 115. The data accelerator unit 330 performs all the activities related to the FSP processing. To execute these activities the data accelerator unit 330 includes (not shown) an interfaces for connecting with the storage controller 340, the TLA 320, and the host's CPU 110; bus controller for controlling data transfers on the interconnected buses 350; a local memory controller for managing the access to local memory 350; a FSP request parser capable of parsing FSP commands and sending them to the host's CPU 110 a host native structure that represents the FSP command; a FSP response generator capable of building and formatting all FSP packets that are sent by network 130. The components of gateway 200 may be hardware components, software components, firmware components, or any combination thereof.

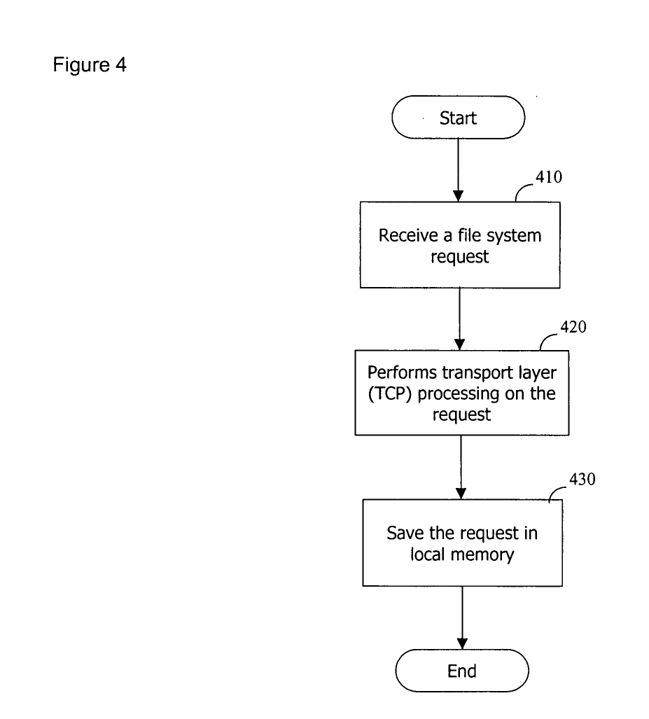

Reference is now made to FIG. 4 where an exemplary flowchart for handling file system requests by gateway 200 is shown. At step 410, gateway 200 receives a file system request from client 170. A file system request may be any request that can be executed by a file system, e.g. read, write, delete, get-attribute, set-attribute, lookup, open, delete, and so on. At step 420, the transport layer (e.g., TCP/IP) performs the processing, such as calculating the checksum for each TCP segments (or UDP datagram) by the TLA 320. At step 430, the request is save in local memory 310 waiting for execution.

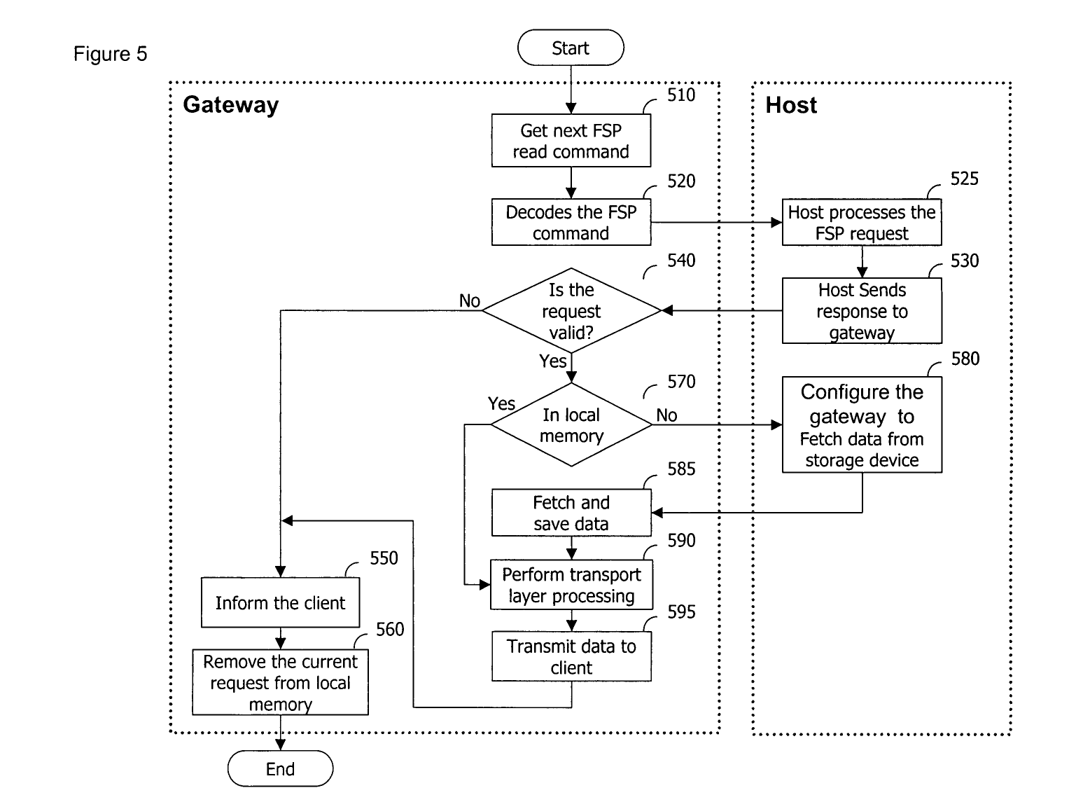

Reference is now made to FIG. 5 where an exemplary flowchart describing the method for handling a read request by gateway 200, in accordance with an embodiment of the present invention, is shown. At step 510, data accelerator unit 330 obtains the next read request to be executed from local memory 310. Typically, a read request (e.g., a FSP read command) includes the logical address of a desired data block in a file. At step 520, data accelerator unit 330 decodes the FSP request and sends to the host's CPU 110 a host's native structure that represents the FSP request. This host's native structure may include, for example, a request for the actual location of the data block designated in FSP request. At step 525, the host's CPU 110 processes the request sent from gateway 200 in order to determine whether the request is valid. For example, the host's CPU 110 may check if the requested data block resides in storage device 150 and if client 170 may be granted access to the requested data. At step 530, the host's CPU 110 sends a response to gateway 200 indicating the status of the FSP request. At step 540, the response sent from the host's CPU 110 is checked. If an error message was received, then at step 550, data accelerator unit 330 informs client 170 that its request is invalid. As a result, at step 560 the current read request is removed from local memory 310. If at step 540, it was determined that the request is valid, execution continues at step 570 where a check is performed to determine if the entire requested data block is cached in local memory 310. If step 570 yields a cache miss, then at step 580, gateway 200 is instructed by the host's CPU to fetch the missing data from storage device 150, through storage interface 160. The respective data is fetched from storage device 150 from a physical location indicated by the host's CPU. The fetched data is saved in local memory 310 in step 585. If step 570 yields a cache hit, then the execution continues with step 590, where transport layer (e.g., TCP) processing is performed in order to transmit the retrieved data block to client 170. For instance, TCP processing includes breaking up the data block into packets, affixing a header to each packet, and sending the packet (each packet at a time) to the destination client 170. After transmitting each packet to the destination address TLA 320 waits for an acknowledge message. In another embodiment data may be sent back to client 170 using a user datagram protocol (UDP). When using the UDP data accelerator unit 330 does not wait to the reception of an acknowledge message from client 170. At step 595, a FSP response is transmitted to client 170 signaling the end of the FSP request execution.

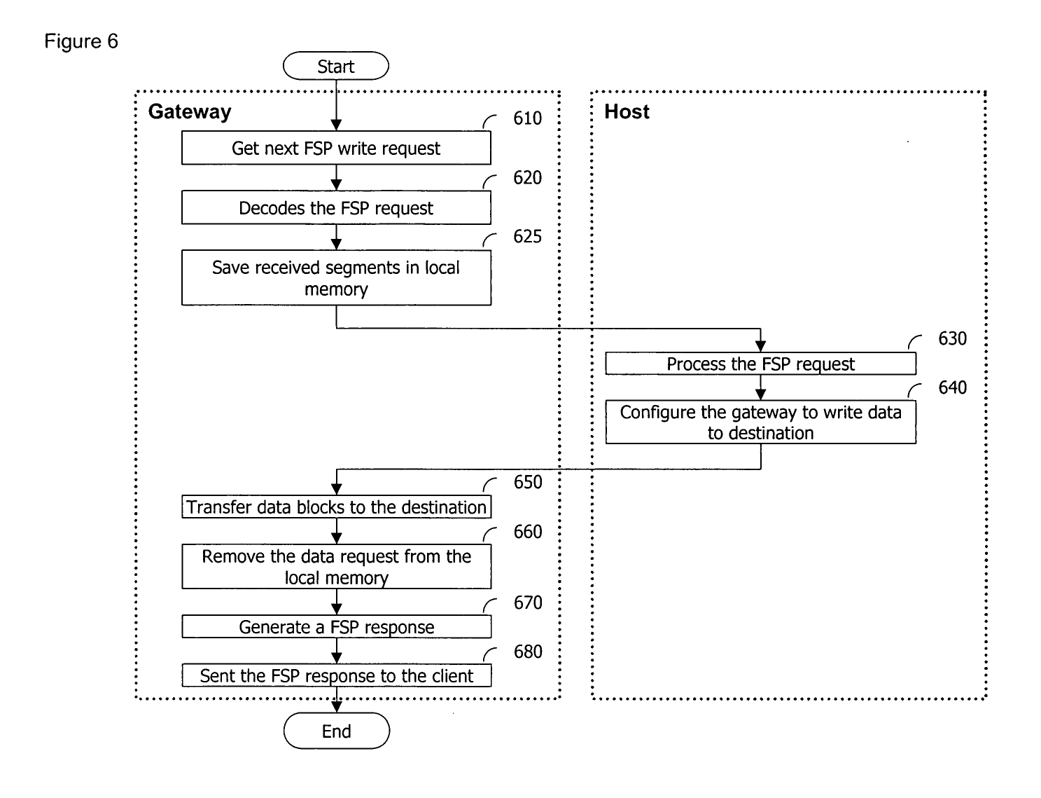

Reference is now made to FIG. 6 where an exemplary flowchart describing the method for handling a write request by gateway 200, in accordance with an embodiment of the present invention, is shown. Typically, the data block to be written is received as a sequence of data segments. A segment is a collection of data bytes sent as a single message. Each segment is sent through network 130 individually, with certain header information affixed to the payload data of the segments. At step 610, data accelerator unit 330 obtains a FSP write request to be executed from local memory 310. The write request includes the logical address indicating where to write the received data block. At step 620, gateway 200 decodes the write request and sends to the host's CPU 110 a native host structure that represents the FSP request. At step 625, the data segments to be written are reconstructed and saved in local memory 310. The reconstruction may take various forms, such as provided, for example, in the related art, to support the specific FSP (e.g., NFS, CIFS, etc.) on the transmitting side. At step 630, the host's CPU 110 processes the request sent from gateway 200. If client 170 has requested to write data in the end of a file or to a new file, then the host's CPU 110 allocates new storage space in the destination storage device 150. At step 640, gateway 200 is configured to write the data block to its destination location. At step 650, the data block is transferred from local memory 110 to the destination storage device, through storage interface 160. At step 660, the current write request is removed from local memory 310. At step 670, gateway 200 generates FSP write response acknowledging that the data blocks were written in the destination storage device (or storage devices) 150. At step 680, the write FSP response is sent to client 170 through network 130.

It should be appreciated by a person skilled in the art that gateway 200, by utilizing the methods described herein, avoids the need to transfer data through the host's working memory 115. Therefore, gateway 200 significantly increases the performance of file server 180. This is achieved mainly because data transfers on the over-congested bus, such as system bus 140, are reduced. The host's CPU 110 is not required to perform FSP processing, nor is it required to manage the data movements between NIC 120 and storage interface 160.

In case the CPU does not include software module for controlling FSP commands processing it is suggested, according to the present invention, that a daemon controller is further included. The daemon controller is a software component which operates in conjunction with the host's CPU 110. Specifically, the daemon controller executes all the activities related to retrieving mapping information from the operating system (OS) of file server 180, controlling the cache memory in local memory 310, and performing all the required action to service FSP commands.

In one embodiment of the present invention, gateway 200 is capable of handling file system operations not requiring massive data transfers. These operations include, but are not limited to, “get attribute”, “set attribute”, “lookup”, as well as others. As a whole, these operations are referred to as metadata operations. In order to accelerate the execution of such operations gateway 200 caches metadata content in local memory 310. For example, in the execution of “get attribute”, gateway 200 first performs a file sharing protocol processing to identify the parameters mandatory for the execution of the request (e.g., file identifier and the designated attribute). Then, gateway 200 accesses its local memory 310 to check whether or not the metadata of the designated file is cached in local memory 310. If so, gateway 200 retrieves the designated attribute and sends it back to client 170, otherwise gateway 200 informs the host's CPU 110 to get the designated attribute from storage device 150.

What is claimed is:

1. A gateway apparatus working in cooperation with a host file server for accelerating file sharing tasks wherein all data transfer operations between storage devices and network devices are processed directly through the gateway, said gateway is comprised of:
storage controller in communication with the storage device;
transport layer accelerator (TLA) in communication with file server network controller;
local memory for storing communication requests;
data accelerator engine (DAE) for processing and decoding FSP commands, said engine is interconnected to the file server central processing unit (CPU) and working memory through internal bus and is interconnected to TLA, the local memory and the storage controller through interconnected buses.

2. The apparatus of claim 1, wherein said local memory is a cache memory.

3. The apparatus of claim 2, wherein the address space of said local memory is configured to match the address space of said file server's working memory.

4. The apparatus of claim 1, wherein said network is at least one of: local area network (LAN), wide area network (WAN).

5. The apparatus of claim 1, wherein said transport layer is able to perform transmission control protocol (TCP) processing of incoming and outgoing data blocks.

6. The apparatus of claim 1, wherein said FSP is at least one of the following protocols: network file system (NFS) protocol, common internet file system (CIFS) protocol, direct access file system (DAFS) protocol, AppleShare protocol.

7. The apparatus of claim 1, wherein said storage controller is at least one of: Fibre Channel (FC), small computer system interface (SCSI), parallel SCSI (pSCSI), iSCSI, parallel ATA (PATA) or serial ATA (SATA).

8. The apparatus of claim 1, wherein said storage device is a least one of: disk drive, collection of disk drives, tape drive, redundant array of independent disks (RAID).

9. The apparatus of claim 1, wherein the interconnected bus is a Peripheral Component Interconnect (PCI).

10. The apparatus of claim 1, wherein said data accelerator engine further comprises:
means for interfacing with the host file sever, said TLA, and said storage controller;
means for parsing incoming FSP commands;
means for generating a FSP response;
means for controlling said local memory.

11. The apparatus of claim 1, wherein TLA performs transport layer processing on a processed FSP command.

12. The apparatus of claim 1, wherein DAE further decodes FSP command, transfers to the host's file server as a native structure of decoded FSP commands, establishes a direct path between said network terminal and said storage controller under control of said host file server and generates a FSP response which ends the session of said FSP command.

13. The apparatus of claim 12 wherein the data transfer of one or more data blocks is processed over said direct path at wire-speed.

14. The apparatus of claim 13, wherein said host file sever provides said gateway with a destination address.

15. The apparatus of claim 13, wherein said destination address comprises: a physical address of said data blocks requested to be read or a physical address indicating where to write said data blocks.

16. The apparatus of claim 2, wherein said gateway further comprises a controller software module which communicates with an operating system of said host file sever for the purpose of controlling the processing of FSP commands.

17. The apparatus of claim 1, wherein said FSP command is at least one of the following file system operations: read, write, get attribute, lookup, set attribute, delete, open.

18. The apparatus of claim 1 wherein the gateway apparatus is connected to the storage controller and NIC through peripheral channels.

19. The apparatus of claim 18 wherein the peripheral channels are at least Peripheral Component Interconnect (PCI) buses.

20. A file server including CPU, working memory, network controller, storage device and a designated gateway, wherein all file data transfer between storage devices connected to the file server and network devices are processed directly through the designated gateway.

21. A file server for accelerating file sharing tasks, said file server comprises of:
a network interface for the purpose of communicating with a network over which data is transferred to said storage devices;
a storage interface for the purpose of interfacing with said storage device; and,
a gateway for processing FSP commands and establishing direct data path for processing all data transfer between the network devices and the storage devices.

22. The file sever of claim 21 wherein the gateway is comprised of:
storage controller in communication with the file server storage device;
transport layer accelerator (TLA) in communication with file server network controller (NIC);
local memory for storing communication requests, (including cache memory for data transfer acceleration)
data accelerator engine (DAE) for processing and decoding FSP commands, said engine interconnects to the file server CPU and working memory through internal bus and interconnects to the TLA, the local memory and the storage controller through interconnect buses.

23. The file sever of claim 22, wherein said local memory includes cache memory.

24. The file sever of claim 21, wherein the address space of said local memory is configured to match the address space of said file server's memory.

25. The file sever of claim 22, wherein said network is at least one of: local area network (LAN), wide area network (WAN).

26. The file sever of claim 22, wherein said transport layer is able to perform transmission control protocol (TCP) processing of incoming and outgoing data blocks.

27. The file sever of claim 22, wherein said FSP is one of the following protocols:
network file system (NFS) protocol, common internet file system (CIFS) protocol, direct access file system (DAFS) protocol, AppleShare protocol.

28. The file sever of claim 22, wherein said storage controller is at least one of: Fibre Channel (FC), small computer system interface (SCSI), parallel SCSI (pSCSI), iSCSI, parallel ATA (PATA) or serial ATA (SATA).

29. The file sever of claim 22, wherein said storage device is a least one of: disk drive, collection of disk drives, tape drive, redundant array of independent disks (RAID).

30. The file sever of claim 22, wherein the interconnect bus is a Peripheral Component Interconnect (PCI).

31. The file sever of claim 22, wherein said data accelerator engine further comprises:
means for interfacing with the host file sever, said TLA, and said storage controller;
means for parsing incoming FSP commands;
means for generating a FSP response;
means for controlling said local memory.

32. The file sever of claim 22, wherein TLA performs transport layer processing on a processed FSP command.

33. The file sever of claim 22, wherein DAE further decodes FSP command, transfers to the host's file server a native structure of decoded FSP commands, establishes a direct path between said network terminal and said storage controller under control of said local file server host and generates a FSP response which ends the session of said FSP command.

34. The file sever of claim 22 wherein the data transfer of one or more data blocks is processed over said direct path at wire-speed.

35. The file sever of claim 22, wherein the file server CPU provides said gateway with a destination address.

36. The file sever of claim 22, wherein said destination address comprises: a physical address of said data blocks requested to be read or a physical address indicating where to write said data blocks.

37. The file sever of claim 22, wherein said gateway further comprises a controller software module which communicates with an operating system of said host file sever for the purpose of controlling the processing of FSP commands.

38. The file sever of claim 22, wherein said FSP command is at least one of the following file system operations: read, write, get attribute, lookup, set attribute, delete, open.

39. The file sever of claim 22 wherein the gateway is connected to the storage controller and NIC through peripheral channels.

40. The file sever of claim 22 wherein the peripheral channels are at least a Peripheral Component Interconnect (PCI) buses.

41. A method for accelerating file transfer between the file server and network terminals, wherein the file server includes a designated gateway, which creates a direct data path between the file server network controller and storage devices connected to the file server, said method comprising the steps of:
receiving FSP commands;
performing transport layer processing of received FSP commands;
decoding FSP commands;
transferring decoded FSP commands native structure to file server CPU;
receiving CPU's response;
establishing direct data path between file server network terminal and file server storage device in accordance with CPU response and FSP commands;
transferring at least one data block through said data path;
generating an FSP response indicating end of FSP session.

42. The method of claim 41, wherein said FSP is at least one of: network file system (NFS) protocol, common Internet file system (CIFS) protocol, direct access file system (DAFS) protocol, AppleShare protocol.

43. The method of claim 41, wherein said transport layer processing includes performing at least TCP processing of incoming data blocks and on outgoing data blocks.

44. The method of claim 41, wherein said network is at least one of: local area network (LAN), wide area network (WAN).

45. The method of claim 41, wherein said FSP command is at least one of the following file system operations: get attribute, lookup, set attribute, delete, open.

46. The method of claim 41, wherein said FSP command is a read command.

47. The method of claim 41, wherein said read command comprises at least one logic address of one or more data blocks in a file.

48. The method of claim 47, wherein said file server response provides a physical address of said requested data blocks.

49. The method of claim 47, wherein prior to generating a FSP response further comprises the steps of:
performing a check to determine if said requested data blocks are cached in a cache memory;
retrieving from a storage device data which is not in said cache memory;
temporarily saving the retrieved data in said cache memory; and,
performing transport layer processing of said data blocks.

50. The method of claim 41 wherein said FSP command is a write command.

51. The method of claim 50 wherein said write command includes one or more data blocks to be written into a file.

52. The method of claim 50 wherein said file server response provides a physical address of said file.

53. The method of claim 50, wherein prior to generating a FSP response, said method further comprises the steps of:
receiving said data blocks from said network;
temporarily saving said data blocks in a cache memory;
synchronizing the writing of said data block with an operating system of said local host; and,
writing said data blocks in a destination storage device.

54. The method of claim 53, wherein said FSP response acknowledges that said data blocks were written in said destination storage device.
